(19) United States
(12) Patent Application Publication
(10) Pub. No.: US 2020/0165146 A1
(43) Pub. Date: May 28, 2020

(54) ION EXCHANGING UNIT

(71) Applicant: DISCO CORPORATION, Tokyo (JP)

(72) Inventor: Osamu YAMANE, Tokyo (JP)

(21) Appl. No.: 16/690,303

(22) Filed: Nov. 21, 2019

(30) Foreign Application Priority Data
Nov. 22, 2018 (JP) 2018-219136

(51) Int. Cl. C02F 1/42

(52) U.S. Cl. CPC C02F 1/42; C02F 2001/427

(57) ABSTRACT

An ion exchanging unit exchanging ions contained in water includes a container for storing a plurality of ion exchange resins, a water supplying path through which to supply water to the container, a pure water discharging path through which to discharge water which has been ion-exchanged by the ion exchange resins, from the container, and a flow suppressing portion suppressing flow of the ion exchange resins by pressing downward the ion exchange resins stored in the container from above. The flow suppressing portion includes a pressing member placed on an upper surface of the ion exchange resins, the pressing member following the ion exchange resins which shrink more in volume as the ion exchange resins are used longer and then moving downward.

### BACKGROUND OF THE INVENTION

### Field of the Invention

The present invention relates to an ion exchanging unit removing an ion contained in water.

### Description of the Related Art

In a purification process of generating pure water to be used for industrial purposes, an ion exchanging unit removing ions not derived from water molecules contained in water is used (refer to, for example, Japanese Patent Laid-open No. 2011-41878 and Japanese Patent Laid-open No. 2007-245005). The ion exchanging unit includes a pressure-resistant container, and ion exchange resins in a bead-like shape tightly sealed into the pressure-resistant container. When water is sent to the container of the ion exchanging unit, the ions contained in the water are exchanged by the ion exchange resins, and pure water is extracted from the container. The ion exchange resins tightly sealed in the container of the ion exchanging unit include anion exchange resins and cation exchange resins, each absorbing the ions contained in the water to thereby remove the ions from the water. When the anion exchange resins and the cation exchange resin are mixed in the container in a tightly sealed manner, the ions contained in the water are efficiently removed and the water is purified, so that pure water is efficiently obtained.

### SUMMARY OF THE INVENTION

When the ion exchanging unit continues to be used, volume of the ion exchange resins stored in the container gradually reduces, and a space in which the ion exchange resins can move is generated inside the container. Then, when water keeps running in the container, the beads of the ion exchange resins start to flow inside the container. In this case, the anion exchange resin and the cation exchange resin differ from each other in specific gravity (density). Accordingly, in the course in which the anion exchange resin and the cation exchange resin flow, each resin becomes localized according to its specific gravity. When the anion exchange resin and the cation exchange resin are separated, the ions contained in the water cannot be efficiently exchanged with ions of the ion exchange resins, and an ion exchange capacity of the ion exchanging unit lowers, causing a possibility that the ion contained in the water cannot be efficiently exchanged with the ions of the ion exchange resins.

Accordingly, it is therefore an object of the present invention to provide an ion exchanging unit capable of suppressing flow of ion exchange resins stored in a container, and preventing the ion exchange resins having different specific gravities from being separated from each other according to each specific gravity.

In accordance with an aspect of the present invention, there is provided an ion exchanging unit exchanging ions contained in water, including: a container for storing a plurality types of ion exchange resins in a bead-like shape, the ion exchange resins having different specific gravities, in a state in which the ion exchange resins are mixed with each other; a water supplying path through which to supply water to the container; a pure water discharging path through which to discharge water which has been ion-exchanged by the ion exchange resins, from the container; and a flow suppressing portion suppressing flow of the ion exchange resins by pressing downward the ion exchange resins stored in the container from above, in which the flow suppressing portion includes a pressing member placed on an upper surface of the ion exchange resins, the pressing member enabling constant pressing of the ion exchange resins as a result of following the ion exchange resins, which shrink more in volume as the ion exchange resins are used longer, and moving downward.

Preferably, the flow suppressing portion further includes an elastic member fixed to the pressing member at one end thereof, and the elastic member energizes the pressing member moving downward in accordance with the shrinkage of the ion exchange resins.

Preferably, the pressing member includes a plate having an area smaller than an area of an upper surface of the ion exchange resins stored in the container.

To the ion exchanging unit according to the aspect of the present invention, water is supplied from the water supplying path. When ions contained in the water thus supplied are exchanged by the ion exchange resins, pure water is generated and then discharged through the pure water discharging path. Also, the ion exchanging unit includes the flow suppressing portion having the pressing member placed on the upper surface of the ion exchange resins. The ion exchange resins stored in the container are pressed downward from above by the flow suppressing portion, thereby enabling flow of the ion exchange resins to be suppressed even when water is supplied in the container. When the ions contained in the water are exchanged by the ion exchange resins, the ion exchange resins gradually decrease in volume. At this time, the pressing member moves downward following the ion exchange resins which keep shrinking, thereby pressing downward the ion exchange resins. In other words, the flow suppressing portion prevents generation of a space in which the ion exchange resins in a bead-like shape can freely flow, and constantly keeps suppressing flow of the ion exchange resins which shrink. When the flow of the ion exchange resins is suppressed, the ion exchange resins are less likely to be separated in accordance with the respective specific gravities, so that lowering of the ion exchange capacity of the ion exchange resins is prevented.

Thus, according to the present invention, there is provided an ion exchanging unit capable of suppressing flow of ion exchange resins contained in a container, and preventing the ion exchange resins having different specific gravities from being separated from each other according to each specific gravity.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically illustrating constituent elements of an ion exchanging unit;

FIG. 2 is a cross-sectional view schematically illustrating the ion exchanging unit before being used;

FIG. 3 is a cross-sectional view schematically illustrating the ion exchanging unit in which ion exchange resins shrink inside a container; and

FIG. 4 is a cross-sectional view schematically illustrating a configuration example of the ion exchanging unit.

### DETAILED DESCRIPTION OF THE PREFERRED EMBODIMENT

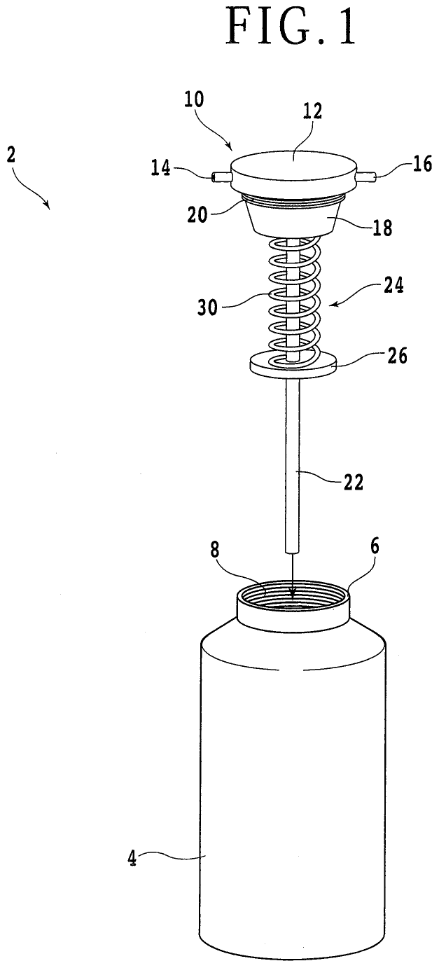

With reference to the attached drawings, one aspect according to an embodiment of the present invention will be described. A description of an ion exchanging unit according to the present embodiment will be given below. FIG. 1 is a perspective view schematically illustrating constituent elements of an ion exchanging unit 2 according to the present embodiment. The ion exchanging unit 2 is, for example, provided in a supplying path for pure water in a manufacturing factory for semiconductor device chips, a manufacturing plant of pharmaceutical products, or the like. The ion exchanging unit 2 has a purification function of removing ions not derived from water molecules from the water containing these ions to obtain pure water. Water to be supplied to the ion exchanging unit 2 (also referred to as raw water) includes, for example, tap water, fresh water, and the like from which floating substances and impurities are removed in advance through a filter, an activated carbon, or the like. Also, the water contains ions other than hydrogen ions and hydroxide ions which are derived from water molecules. The ion exchanging unit 2 according to the present embodiment exchanges the ions that are other than the ions which are derived from water molecules and that are contained in the supplied water and removes such other ions therefrom, to obtain pure water.

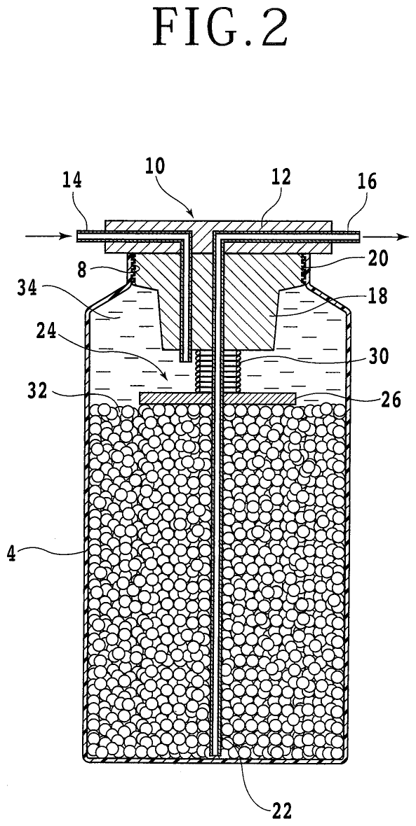

The ion exchanging unit 2 includes, for example, a pressure-resistant container 4 in which ion exchange resins for exchanging ions are stored. An upper portion of the container 4 has a circular opening portion 6 formed thereat, and the opening portion 6 has an internal thread 8 formed at an inner wall thereof. A head portion 10 is screwed onto the container 4, the head portion 10 including a water supplying path 14 serving as a supplying channel for feeding water to the container 4, and a pure water discharging path 16 serving as a discharging channel for pure water which is generated in the container 4. FIG. 2 is a cross-sectional view schematically illustrating the ion exchanging unit 2 in which the head portion 10 is screwed onto the container 4 in which the ion exchange resins 32 are filled. The head portion 10 further includes a disk-shaped lid member 12 to which the water supplying path 14 and the pure water discharging path 16 are fixed, and a supporting member 18 fixed to a lower portion of the lid member 12. The water supplying path 14 horizontally passes from a side surface of the lid member 12 therethrough, is bent downward inside the lid member 12, penetrates the supporting member 18 in a vertical direction, and is extending down below the supporting member 18. The pure water discharging path 16 is disposed on an opposite side to the water supplying path 14, horizontally passes from the side surface of the lid member 12 therethrough, is bent downward substantially at a center inside the lid member 12, penetrates the supporting member 18 in the vertical direction, and is extending down below the supporting member 18.

An amount at which the water supplying path 14 protrudes downward from a lower surface of the supporting member 18 is relatively small, and accordingly, when the head portion 10 is screwed onto the container 4, a lower end of the water supplying path 14 reaches a height position of an upper portion inside the container 4. In contrast, the pure water discharging path 16 includes a water collecting pipe 22 greatly protruding from the lower surface of the supporting member 18. A length of the water collecting pipe 22 is a length at which a lower end of the water collecting pipe 22 reaches a height position around a bottom portion of the container 4 when the head portion 10 is screwed onto the container 4. An upper portion of the supporting member 18 has an outer diameter corresponding to an inner diameter of the opening portion 6 of the container 4, and an outer peripheral portion of the upper portion of the supporting member 18 has an external thread 20 formed thereat, the external thread 20 corresponding to the internal thread 8 formed at the inner wall of the opening portion 6 of the container 4. When the head portion 10 is screwed onto the container 4, the external thread 20 at the upper portion of the supporting member 18 is engaged with the internal thread 8 of the opening portion 6 of the container 4.

The head portion 10 further includes an elastic member 30 an upper end of which is fixed to the lower surface of the supporting member 18, and a pressing member 26 fixed to a lower end of the elastic member 30. The elastic member 30 is, for example, a coil spring having a winding portion through which the water collecting pipe 22 of the pure water discharging path 16 passes in the center thereof. The elastic member 30 is formed of, for example, a metal such as stainless steel, or a resin material. Also, the pressing member 26 is a disk-shaped member with an insertion hole penetrating in the vertical direction at the center thereof. The pressing member 26 is formed to have an outer diameter smaller than the inner diameter of the opening portion 6 of the container 4 such that the pressing member 26 can pass through the opening portion 6 of the container 4 when the head portion 10 is screwed onto the container 4. Also, an inner diameter of the insertion hole of the pressing member 26 corresponds to an outer diameter of the water collecting pipe 22 of the pure water discharging path 16, and the water collecting pipe 22 passes through the insertion hole. The pressing member 26 is formed of, for example, a resin plate, a resin sheet, or the like.

The pressing member 26 is movable along an extending direction of the water collecting pipe 22, and energized along the extending direction by the elastic member 30. The pressing member 26 and the elastic member 30 function as a flow suppressing portion which suppresses flow of the ion exchange resins 32 by pressing downward the ion exchange resins 32 stored in the container 4 from above.

A plurality of ion exchange resins 32 are filled in the container 4 in advance. The ion exchange resins 32 are each formed in a bead-like shape with a size of substantially 0.5 to 1.0 mm in diameter, for example. The ion exchange resin 32 has an ion exchange group at part of its molecule structure and is a resin providing an ion exchange effect by taking therein an ion contained in water supplied and releasing a particular ion from the ion exchange group. The ion exchange resins 32 to be loaded in the container 4 are a mixture in which two kinds of ion exchange resins that are anion exchange resins and cation exchange resins are included. The anion exchange resin provides an effect of taking therein anions other than hydroxide ions contained in water and releasing the hydroxide ions to the water, for example. In contrast, the cation exchange resin provides an effect of taking therein cations other than hydrogen ions contained in the water and releasing the hydrogen ions to the water. When the anion exchange resins and the cation exchange resins are mixed with each other and tightly sealed in the container 4 in such a state as to be well dispersed with each other, the ions contained in the water are exchanged efficiently, and the water supplied in the container 4 is purified to thereby obtain pure water.

When the ion exchanging unit 2 is used, water to be ion-exchanged is supplied above the ion exchange resins 32 inside the container 4 through the water supplying path 14. Water 34 supplied in the container 4 moves to a bottom portion inside the container 4 while coming into contact with the ion exchange resins 32. At this time, ions contained in the water 34 are exchanged by the ion exchange resins 32 as described above, and the water 34 is purified, thereby obtaining pure water. The pure water thus obtained enters inside the water collecting pipe 22 from a water collecting port formed at the lower end of the water collecting pipe 22 of the pure water discharging path 16, moves upward by a suppling pressure of the water 34 passing through the water supplying path 14, then passes through the pure water discharging path 16, and is discharged outside the container 4.

When the ions contained in the water 34 are exchanged by using the ion exchange resins 32, the water 34 is purified, and pure water is accordingly generated, the ion exchange resins 32 gradually shrink. As a result, a volume of a region occupied by the ion exchange resins 32 inside the container 4 gradually becomes small. Then, flowing stream of the water 34 supplied from the water supplying path 14 results in that the ion exchange resins 32 are stirred up in the water 34 and moving. In this case, the anion exchange resins and the cation exchange resins differ from each other in specific gravity (density). Accordingly, the anion exchange resins and the cation exchange resins are gradually localized in accordance with their specific gravities in the course of moving. When the anion exchange resins and the cation exchange resins are separated, the ions contained in the water 34 cannot be efficiently exchanged, so that the ion exchange capacity of the ion exchange unit 2 lowers, failing in sufficient exchange of the ions contained in the water 34.

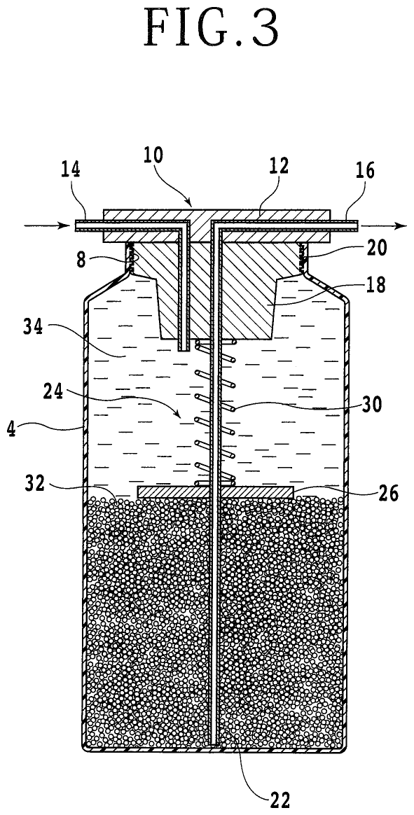

However, the ion exchange unit 2 according to an aspect of the present invention includes a flow suppressing portion 24. The pressing member 26 included in the flow suppressing portion 24 presses downward the ion exchange resins 32 from above. Hence, the ion exchange resins 32 are prevented from being stirred up due to flowing stream of the water 34 supplied from the water supplying path 14, and localization of the anion exchange resins and the cation exchange resins is accordingly prevented. FIG. 3 is a cross-sectional view schematically illustrating the ion exchanging unit 2 in which the ion exchange resins 32 shrink inside the container 4. As illustrated in FIG. 3, when the ion exchange resins 32 shrink, the pressing member 26 follows the ion exchange resins 32 and then moves downward in accordance with the shrinkage of the ion exchange resins 32. As a result, the pressing member 26 can constantly press downward the ion exchange resins 32 from above. Accordingly, in the ion exchanging unit 2 of the present embodiment, localization of the anion exchange resins and the cation exchange resins continues to be suppressed, so that the ion exchanging unit 2 can provide a predetermined ion exchange capacity for a long period of time. Note that, in a case in which the coil spring is used in the elastic member 30, a length, a spring constant, and the like are properly set such that the coil spring as the elastic member 30 can follow the ion exchange resins 32, which keep shrinking, for a long period of time, for example.

In a case in which the use of the ion exchanging unit 2 has been continued and the ion exchanging unit 2 reaches an end of service life such that the ions contained in the water 34 cannot be sufficiently exchanged, recycle or replacement of the ion exchange resins 32 is carried out. For example, in a case in which the ion exchange resins 32 are replaced with new ones, the head portion 10 is taken off from the container 4, and the ion exchange resins 32 which have been used up and are stored in the container 4 are taken out from the container 4. Instead, the ion exchange resins 32 which are unused are filled in the container 4, and then, the head portion 10 is screwed onto the container 4. Monitoring of the ion exchange capacity of the ion exchanging unit 2 is carried out by measuring a specific resistance of pure water to be discharged from the pure water discharging path 16, for example. When the ions that are not derived from the water molecules and are contained in the pure water are sufficiently small in number, i.e., the ions not derived from the water molecules are sufficiently removed, the specific resistance of the pure water becomes relatively high. Conversely, when the ions not derived from the water molecules are not sufficiently removed, the specific resistance of the pure water becomes relatively low. In view of this, the ion exchanging unit 2 may have a specific resistance measuring unit, which measures a specific resistance of pure water flowing through the pure water discharging path 16, provided on the lid member 12, for example.

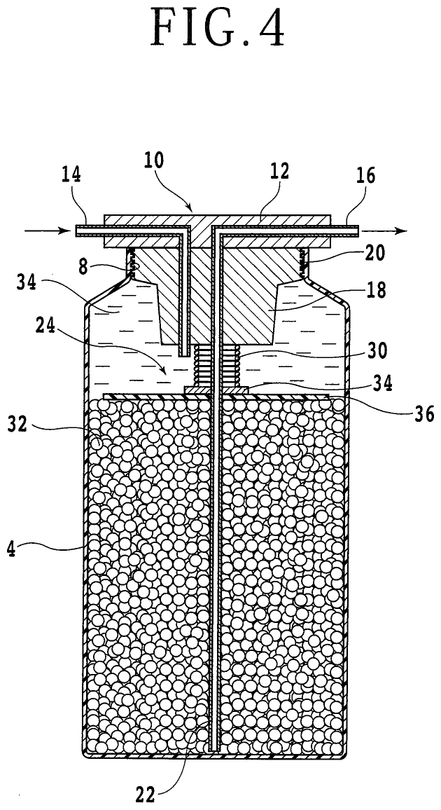

Note that strength of an effect of suppressing flow of the ion exchange resins 32 by the flow suppressing portion is determined according to a size of the pressing member 26, strength of energization of the pressing member 26 by the elastic member 30, and the like. In view of this, in order to obtain a much larger effect of suppressing flow of the ion exchange resins 32, an area of a lower surface of the pressing member 26 may be made large. However, when the area of the lower surface of the pressing member 26 is made too large, the pressing member 26 does not pass through the opening portion 6 when the head portion 10 is screwed onto the container 4. To solve this problem, the flow suppressing portion 24 may be formed of a material having flexibility, for example, a rubber, without using the pressing member 26 formed of a hard resin plate or the like. For example, in FIG. 4, indicated is a cross-sectional view schematically illustrating another configuration example of the ion exchanging unit 2. The flow suppressing portion 24 in FIG. 4 includes an elastic member 30, a supporting plate 38 fixed to a lower end of the elastic member 30, and a pressing member 36 attached to a lower surface of the supporting plate 38 in a deformable manner.

In this case, when the head portion 10 is screwed onto the container 4, the pressing member 36 is deformed so as to pass through the opening portion 6 of the container 4, and then, is expanded inside the container 4. When a material having flexibility is used for the pressing member 36, the lower surface of the pressing member 36 can be configured to have an area larger than a cross-sectional area of the opening portion 6 of the container 4. Accordingly, it is possible to suppress flow of the ion exchange resins 32 more positively. Note that, however, when the area of the lower surface of the pressing member 36 is set larger than a cross-sectional area of a main body of the container 4, the water 34 cannot move between the pressing member 36 and an inner wall of the container 4. Accordingly, the pressing member 36 is configured to have an area smaller than an area of the entire upper surface of the plurality of ion exchange resins 32 stored in the container 4.

As described above, when the ion exchanging unit 2 according to the aspect of the present invention is used, the ion exchange resins 32 which keep shrinking as they are used can be constantly pressed, so that it is possible to suppress the flow of the ion exchange resins 32 and to prevent the ion exchange resins which differ from each other in specific gravity from being separated according to respective specific gravities.

Note that the present invention is not limited to the description of the foregoing embodiment, and various modifications are applicable. For example, in the foregoing embodiment, a case in which water which is a target to be ion-exchanged is supplied inside the container 4 through the water supplying path 14 and the generated pure water is discharged outside the container 4 through the pure water discharging path 16 has been described by way of example; however, the aspect of the present invention is not limited to this case. For example, the water which is a target to be ion-exchanged may be supplied through the pure water discharging path 16 inside the container 4. In this case, the water supplied to the bottom portion of the container 4 moves upward inside the container 4, ions contained in the supplied water are exchanged by the ion exchange resins 32, and then, pure water is generated. Then, when the pure water reaches the water supplying path 14, the pure water is discharged outside through the water supplying path 14.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. An ion exchanging unit exchanging ions contained in water, comprising:
a container for storing a plurality types of ion exchange resins in a bead-like shape, the ion exchange resins having different specific gravities, in a state in which the ion exchange resins are mixed with each other;
a water supplying path through which to supply water to the container;
a pure water discharging path through which to discharge water which has been ion-exchanged by the ion exchange resins, from the container; and
a flow suppressing portion suppressing flow of the ion exchange resins by pressing downward the ion exchange resins stored in the container from above,
wherein the flow suppressing portion includes a pressing member placed on an upper surface of the ion exchange resins, the pressing member enabling constant pressing of the ion exchange resins as a result of following the ion exchange resins which shrink more in volume as the ion exchange resins are used longer and moving downward.

2. The ion exchanging unit according to claim 1,
wherein the flow suppressing portion further includes an elastic member fixed to the pressing member at one end thereof, and
the elastic member energizes the pressing member moving downward in accordance with the shrinkage of the ion exchange resins.

3. The ion exchanging unit according to claim 1,
wherein the pressing member includes a plate having an area smaller than an area of an upper surface of the ion exchange resins stored in the container.
